(19) United States
(12) Patent Application Publication
(10) Pub. No.: US 2023/0262683 A1
(43) Pub. Date: Aug. 17, 2023

(54) METHOD AND SYSTEM FOR DEEP REINFORCEMENT LEARNING (DRL) BASED SCHEDULING IN A WIRELESS SYSTEM

(71) Applicant: Telefonaktiebolaget LM Ericsson (publ), Stockholm (SE)

(72) Inventors: Vidit Saxena, Järfälla (SE); Jakob Stigenberg, Stockholm (SE); Soma Tayamon, Stockholm (SE); Euhanna Ghadimi, Bromma (SE)

(21) Appl. No.: 18/015,222

(22) PCT Filed: Jul. 7, 2021
(86) PCT No.: PCT/SE2021/050692

§ 371 Date: Jan. 9, 2023

Related U.S. Application Data
(60) Provisional application No. 63/050,502, filed on Jul. 10, 2020.

(51) Int. Cl. H04W 72/1263; H04W 72/54

(52) U.S. Cl. CPC H04W 72/1263; H04W 72/54

(57) ABSTRACT

Systems and methods are disclosed herein for Deep Reinforcement Learning (DRL) based packet scheduling. In one embodiment, a method performed by a network node for DRB-based scheduling comprises performing a DRL-based scheduling procedure using a preference vector for a plurality of network performance metrics correlated to one of a plurality of desired network performance behaviors, the preference vector defining weights for the plurality of network performance metrics correlated to the one of the plurality of desired network performance behaviors. In this manner, DRL-based scheduling is provided in a manner in which multiple performance metrics are jointly optimized.

### RELATED APPLICATIONS

This application claims the benefit of provisional patent application Ser. No. 63/050,502, filed Jul. 10, 2020, the disclosure of which is hereby incorporated herein by reference in its entirety.

### TECHNICAL FIELD

The present disclosure relates to scheduling in a wireless system such as a cellular communications system.

### BACKGROUND

A cellular base station (BS) concurrently serves several tens or hundreds of User Equipments (UEs). To achieve good Quality of Service (QoS) for each UE, the BS needs to effectively distribute the shared radio resources across the served data flows. State-of-the-art cellular networks achieve this by multiplexing the data flows over discrete time spans and frequency slices, which together constitute Physical Resource Blocks (PRBs) of fixed or variable size.

PRBs are assigned to different data flows through a scheduling algorithm run at every Transmission Time Interval (TTI). The scheduling algorithm, also known as the scheduler, is therefore a key component in ensuring good QoS to each of the served data flows. In Long Term Evolution (LTE) networks, scheduling is primarily done using heuristics or manually shaped priorities for different data flows. Common scheduling algorithms include round robin, proportional fair, and exponential rule algorithms. Round robin is one of the basic scheduling algorithms. It prioritizes UEs based on their time since last transmission and, thus, does not account for other metrics, such as channel quality, fairness, or QoS requirements, in its decision making. Proportional fair, on the other hand, attempts to exploit the varying channel quality in order to provide fairness to all UEs in the network. Rather than maximizing network performance by consistently scheduling UEs with the best channel quality, proportional fair prioritizes UEs according to the ratio of their expected data rate and their mean data rate. By relating a UE's expected data rate to their mean data rate, fairness is achieved for all UEs. However, QoS requirements are not considered in this approach. The exponential rule algorithm attempts to introduce QoS awareness into the proportional fair algorithm, thus providing QoS and channel quality awareness. This is done by increasing the priority of a UE exponentially with their current head-of-line delay.

However, in New Radio (NR), the available time and frequency resources can be scheduled with much more flexibility compared to the previous generation of cellular systems. Therefore, efficiently scheduling the available resources has become much more complex. The increased complexity results in increased difficulty in designing ‘good’ heuristics that efficiently handle the diverse QoS requirements across data flows and also makes it difficult to maintain a good cellular performance over the dynamic cell states. To facilitate complex scheduling policies, Deep Reinforcement Learning (DRL) based schemes have recently been proposed for scheduling in cellular networks.

The use of DRL in Radio Resource Management (RRM) is a relatively new field. At a high level, DRL-based scheduling aims to explore the space of scheduling policies through controlled trials, and subsequently exploit this knowledge to allocate radio resources to the served UEs. Work in this area includes I. Comsa, A. De-Domenico and D. Ktenas, “QoS-Driven Scheduling in 5G Radio Access Networks—A Reinforcement Learning Approach,” GLOBECOM 2017-2017 IEEE Global Communications Conference, 2017, pp. 1-7, doi: 10.1109/GLOCOM.2017.8254926, which is hereinafter referred to as the “Comsa Paper”. The authors of the Comsa Paper consider a set of popular scheduling algorithms used in LTE. Then, they apply a DRL algorithm to, at each TTI, decide which scheduling algorithm to apply. Other work includes Chinchali, S., P. Hu, T. Chu, M. Sharma, M. Bansal, R. Misra, M. Pavone, and S. Katti, “Cellular Network Traffic Scheduling With Deep Reinforcement Learning”, Proceedings of the AAAI Conference on Artificial Intelligence, vol. 32, no. 1, April 2018, https://ojs.aaai.org/index.php/AAAI/article/view/11339, which is hereinafter referred to as the “Chinchali Paper”. The authors of the Chinchali Paper investigate High-Volume-Flexible-Time (HVFT) traffic. This is traffic that typically originates from Internet of Things (I) devices. They use a DRL algorithm to decide the amount of HVFT that should be scheduled in the current TTI.

### SUMMARY

Systems and methods are disclosed herein for Deep Reinforcement Learning (DRL) based packet scheduling. In one embodiment, a method performed by a network node for DRB-based scheduling comprises performing a DRL-based scheduling procedure using a preference vector for a plurality of network performance metrics correlated to one of a plurality of desired network performance behaviors, the preference vector defining weights for the plurality of network performance metrics correlated to the one of the plurality of desired network performance behaviors. In this manner, DRL-based scheduling is provided in a manner in which multiple performance metrics are jointly optimized.

In one embodiment, the method further comprises obtaining a plurality of preference vectors for respective sets of network performance metrics for the plurality of desired network performance behaviors, respectively.

In one embodiment, the plurality of network performance metrics comprises: (a) packet size, (b) packet delay, (c) Quality of Service (QoS) requirement(s), (d) cell state, or (e) a combination two or more of (a)-(d).

In one embodiment, further comprising selecting the preference vector from among a plurality of preference vectors for respective sets of network performance metrics for a plurality of network performance behaviors, respectively. In one embodiment, selecting the preference vector from among the plurality of preference vectors comprises selecting the preference vector from among the plurality of preference vectors based on one or more parameters. In one embodiment, the selected preference vector varies over time. In one embodiment, the one or more parameters comprise time of day or traffic type.

In one embodiment, the DRL-based scheduling procedure is a Deep Q-Learning Network (DQN) scheduling procedure.

In one embodiment, the DRL-based scheduling procedure performs time-domain scheduling of packets for each of a plurality of transmit time intervals (ills).

In one embodiment, the method further comprises, prior to performing the DRL-based scheduling procedure, determining the preference vector for the desired network performance behavior.

In one embodiment, the method further comprises, prior to performing the DRL-based scheduling procedure, for each desired network performance behavior of the plurality of desired network performance behaviors, training a DRL-based policy for each of a plurality of candidate preference vectors for a plurality of network performance metrics correlated to the desired network performance behavior based on respective composite reward functions, each composite reward function being based on the plurality of network performance metrics correlated to the desired network performance behavior and a respective one of the plurality of candidate preference vectors, and selecting, based on results of the training, the preference vector for the plurality of network performance metrics correlated to the desired network performance behavior from among the plurality of candidate preference vectors for the plurality of network performance metrics correlated to the desired network performance behavior.

Corresponding embodiments of a network node are also disclosed. In one embodiment, a network node for DRB-based scheduling is adapted to perform a DRL-based scheduling procedure using a preference vector for a plurality of network performance metrics correlated to one of a plurality of desired network performance behaviors, the preference vector defining weights for the plurality of network performance metrics correlated to the one of the plurality of desired network performance behaviors.

In one embodiment, a network node for DRB-based scheduling comprises processing circuitry configured to cause the network node to perform a DRL-based scheduling procedure using a preference vector for a plurality of network performance metrics correlated to one of a plurality of desired network performance behaviors, the preference vector defining weights for the plurality of network performance metrics correlated to the one of the plurality of desired network performance behaviors.

In one embodiment, a computer-implemented method of training a DRL-based scheduling procedure comprises, for each desired network performance behavior of a plurality of desired network performance behaviors, training a DRL-based policy for each of a plurality of candidate preference vectors for a plurality of network performance metrics correlated to the desired network performance behavior based on respective composite reward functions, each composite reward function being based on the plurality of network performance metrics correlated to the desired network performance behavior and a respective one of the plurality of candidate preference vectors; and selecting, based on results of the training, a preference vector for the plurality of network performance metrics correlated to the desired network performance behavior from among the plurality of candidate preference vectors for the plurality of network performance metrics correlated to the desired network performance behavior based on results of the training.

Corresponding embodiments of a computing node or network node are also disclosed. In one embodiment, a computing node or a network node is adapted to, for each desired network performance behavior of a plurality of desired network performance behaviors, training a DRL-based policy for each of a plurality of candidate preference vectors for a plurality of network performance metrics correlated to the desired network performance behavior based on respective composite reward functions, each composite reward function being based on the plurality of network performance metrics correlated to the desired network performance behavior and a respective one of the plurality of candidate preference vectors; and selecting, based on results of the training, a preference vector for the plurality of network performance metrics correlated to the desired network performance behavior from among the plurality of candidate preference vectors for the plurality of network performance metrics correlated to the desired network performance behavior based on results of the training.

In one embodiment, a method performed by a network node for Deep DRL-based scheduling comprises determining, for each desired network performance behavior of a plurality of desired network performance behaviors, a preference vector to apply to a plurality of network performance metrics correlated to the desired network performance behavior, during a training phase of a DRL-based scheduling procedure that optimizes a composite reward generated from the plurality of network performance vectors using the preference vector. The method further comprises, during an execution phase of the DRL-based scheduling procedure, performing the DRL-based scheduling procedure using the determined preference vector for the plurality of network performance metrics correlated to one of the plurality of desired network performance behaviors.

In one embodiment, determining the preference vector for each desired network performance behavior of the plurality of desired network performance behaviors comprises, for each desired network performance behavior of the plurality of desired network performance behaviors, training a DRL-based policy for each of a plurality of candidate preference vectors for the plurality of network performance metrics correlated to the desired network performance behavior based on respective composite reward functions, each composite reward function being based on the plurality of network performance metrics correlated to the desired network performance behavior and a respective one of the plurality of candidate preference vectors, and selecting, based on results of the training, the preference vector for the plurality of network performance metrics correlated to the desired network performance behavior from among the plurality of candidate preference vectors for the plurality of network performance metrics correlated to the desired network performance behavior.

Corresponding embodiments of a network node are also disclosed. In one embodiment, a network node for Deep DRL-based scheduling is adapted to determine, for each desired network performance behavior of a plurality of desired network performance behaviors, a preference vector to apply to a plurality of network performance metrics correlated to the desired network performance behavior, during a training phase of a DRL-based scheduling procedure that optimizes a composite reward generated from the plurality of network performance vectors using the preference vector. The network node is further adapted to, during an execution phase of the DRL-based scheduling procedure, performing the DRL-based scheduling procedure using the determined preference vector for the plurality of network performance metrics correlated to one of the plurality of desired network performance behaviors.

In one embodiment, a network node for Deep DRL-based scheduling comprises processing circuitry configured to cause the network node to determine, for each desired network performance behavior of a plurality of desired network performance behaviors, a preference vector to apply to a plurality of network performance metrics correlated to the desired network performance behavior, during a training phase of a DRL-based scheduling procedure that optimizes a composite reward generated from the plurality of network performance vectors using the preference vector. The processing circuitry is further configured to cause the network node to, during an execution phase of the DRL-based scheduling procedure, performing the DRL-based scheduling procedure using the determined preference vector for the plurality of network performance metrics correlated to one of the plurality of desired network performance behaviors.

In one embodiment, embodiments of a computer program product are also disclosed herein.

In one embodiment, a method performed by a network node for DRL-based scheduling comprises, for each desired network performance behavior of a plurality of desired network performance behaviors, determining a preference vector for a plurality of network performance metrics correlated to the desired network performance behavior, the preference vector defining weights for the plurality of network performance metrics correlated to the desired network performance behavior. The method further comprises performing a DRL-based scheduling procedure using the preference vector for the plurality of network performance metrics correlated to one of the plurality of desired network performance behaviors.

In one embodiment, for each desired network performance behavior of the plurality of desired network performance behaviors, determining the preference vector for the plurality of network performance metrics correlated to the desired network performance behavior comprises training a DRL-based policy for each of a plurality of candidate preference vectors for the plurality of network performance metrics correlated to the desired network performance behavior based on respective composite reward functions, each composite reward function being based on the plurality of network performance metrics correlated to the desired network performance behavior and a respective one of the plurality of candidate preference vectors, and selecting, based on results of the training, the preference vector for the plurality of network performance metrics correlated to the desired network performance behavior from among the plurality of candidate preference vectors for the plurality of network performance metrics correlated to the desired network performance behavior.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system according to some embodiments of the present disclosure;

FIG. 2 illustrates a method according to an embodiment of the present disclosure;

FIG. 3 is a block diagram that illustrates a Deep Reinforcement Learning (DRL) based scheduling procedure for a cellular network in accordance with an embodiment of the present disclosure;

FIG. 4 is a block diagram that illustrates a training phase in which the optimal preference vector is determined and an execution phase in which the determined preference vector is used to control a scheduler in accordance with an embodiment of the present disclosure;

FIG. 5 is a block diagram that illustrates the scheduler being controlled through the chosen preference vector (e.g., solely through the chosen preference vector) for the given desired network performance behavior in accordance with an embodiment of the present disclosure;

FIG. 6 is a schematic block diagram of a radio access node according to some embodiments of the present disclosure;

FIG. 7 is a schematic block diagram that illustrates a virtualized embodiment of the radio access node of FIG. 6 according to some embodiments of the present disclosure; and

FIG. 8 is a schematic block diagram of the radio access node of FIG. 6 according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN (e.g., a radio access node) or the core network of a cellular communications network/system.

Desired Network Performance Behavior: As used herein, the term “desired network performance behavior” refers to a way in which a network (e.g., a cellular communications network) is to perform. For example, one desired network performance behavior is to maximize the throughput of an entire cell traffic. Another example is to maximize throughput of Mobile Broadband (MBB) traffic. As another example, a desired network performance behavior is to optimize various Quality of Service (QoS) metrics such as, e.g., maximizing voice satisfaction (through minimizing packet delay), satisfying data flows associated with high-priority users, decreasing jitter, and/or the like. In some cases, the desired network performance behaviors are defined by the network operator(s).

Deep Reinforcement Learning based Policy: As used herein, a DRL-based policy is a “policy” that is trained for a DRL-based procedure. The policy represented as, for example, a neural network or weights that define an output for a given input to the DRL-based procedure. In terms of scheduling for a cellular communications system, the policy of a DRL-based scheduler defines an output of the scheduler for a given input to the scheduler.

Network Performance Metric: As used herein, a “network performance metric” is any metric or parameter that is indicative of a performance of a network. Some examples include network throughput, fairness, transmission delay, QoS satisfaction, packet loss, or the like.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). The scheduler in a modern cellular base station (BS) needs to address multiple objectives related to cellular performance. These objectives are often in conflict, so that assigning a higher importance to a certain performance metric causes some other metric to get degraded. For example, the scheduler can increase the throughput for a data flow by allocating more radio resources to it. However, this comes at the cost of higher packet delays for data flows that compete for the same set of radio resources. Hence, the scheduler needs to trade-off between increasing the throughput and reducing the average packet delay. Unfortunately, finding an optimal balance between throughput and packet delays is challenging on account of diverse Quality of Service (QoS) requirements and the dynamic nature of the scheduling process.

In addition to throughput and delay, there may be additional QoS requirements related to a data flow, for example packet error rate, guaranteed bitrate, maximum retransmission attempts, etc., which further complicate the scheduling process as these requirements also need to be incorporated into heuristic algorithms, such as the ones discussed in the Background section. New use-cases may also introduce new such requirements, making maintenance of heuristics a big issue.

Furthermore, the optimal trade-off between the cellular performance metrics depends on operator preferences, the number of users (i.e., the number of UEs) in the cell, the characteristics (i.e., the rate and the duration) of the served data flows, and additional factors. These trade-offs are difficult to control efficiently using existing approaches as they are not explicitly controlled by the parameters in heuristic algorithms.

Previous work that does include the use of Deep Reinforcement Learning (DRL) does not use it to fully control the scheduling process; that is, in previous work, DRL is not used end-to-end. Instead, DRL algorithms are typically used to make decisions on a higher level, e.g. which scheduling algorithm to apply at a specific Transmit Time Interval (TTI) or the amount of traffic that should be scheduled from some specific traffic type. Additionally, they do not allow for an operator to control the behavior of the network, as one can theoretically do by tuning heuristic algorithms. However, as previously noted, tuning heuristic algorithms is a highly impractical and time-consuming process.

Certain aspects of the present disclosure and their embodiments may provide solutions to the aforementioned or other challenges. In the solution disclosed herein, a method to flexibly balance the various cellular performance metrics during the DRL scheduling process is disclosed. In one embodiment, a vector of weight values (i.e., a preference vector) is applied over the set of performance metrics. The preference vector is specified based on one of, or a combination of, several factors such as, for example, the QoS requirements, priority values associated with the data flow and the UEs, and the dynamic cell state. This preference vector is used to generate a composite reward function that is subsequently optimized to obtain the DRL scheduling policy.

In one embodiment, a method for assigning a preference vector to one or more performance metrics that are influenced by packet scheduling in cellular networks is provided. In one embodiment, the preference vector comprises scalar weight values that are applied to the corresponding performance metrics in order to generate a composite reward function (which may also be referred to as a composite objective function or composite utility function). In one embodiment, the preference vector is determined on the basis of any one or any combination of two or more of the following factors:
relative importance of a performance metric in relation to the other performance metrics;
cell-level information such as the cell load, number of active users (i.e., the number of active UEs), statistical information regarding the data flows, etc.;
user-level information including the priority level for each user (i.e., UE), QoS requirements for the served data flows, UE capabilities, etc.;
information from other cells regarding the suitable values for the preference vector in relation to one or more cell states;
the choice of model used within a DRL framework, for example deep Q networks, actor-critic, etc.;
the choice of reward function optimized by the optimization scheme, for example, mean squared loss, cross entropy loss, etc.;
the choice of optimization algorithm used for obtaining the scheduling policy, for example, stochastic gradient descent, ADAM, etc.

Certain embodiments may provide one or more of the following technical advantage(s). For example, compared to previous work, embodiments of the solution proposed herein:
Use DRL to fully control the scheduling process, that is end-to-end use of DRL. Specifically, a method is proposed to jointly optimize multiple performance metrics.
Provide the ability to optimally control the tradeoff between competing performance objectives/Key Performance Indicators (KPIs) in a network and thus the behavior of the live network.
Allow for a richer design of the reward function (e.g., by using a composite reward function and a preference vector for weighting a respective set of performance metrics), e.g. by allowing for external additional factors such as the type and priority of individual users and data flows to be included in the scheduling policy. This increases the flexibility in the design of the scheduling process to diverse states of the cellular network and performance goals.

An initial study has shown promising results in controlling the tradeoff between QoS of Voice of Internet Protocol (VoIP) users and aggregated throughput of the network. In the specific scenario used for the initial study, delayed VoIP packets were reduced by 30% while simultaneously improving network throughput by approximately 20%, compared to the state-of-the-art priority-based scheduler.

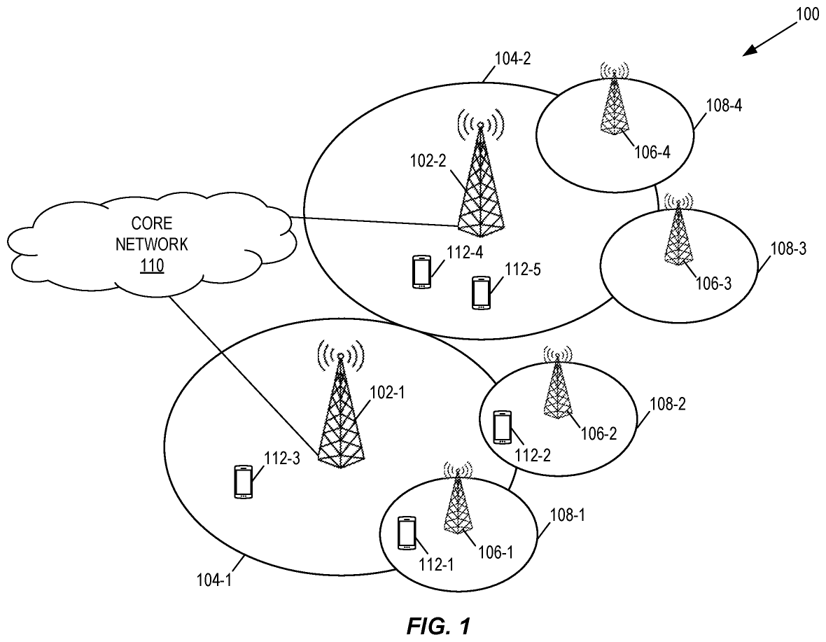

FIG. 1 illustrates one example of a cellular communications system 100 in which embodiments of the present disclosure may be implemented. In the embodiments described herein, the cellular communications system 100 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC); however, the embodiments disclosed herein are not limited thereto. In this example, the RAN includes base stations 102-1 and 102-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5G System (5GS) is referred to as the 5GC. The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs and as such sometimes referred to herein as UEs 112, but the present disclosure is not limited thereto.

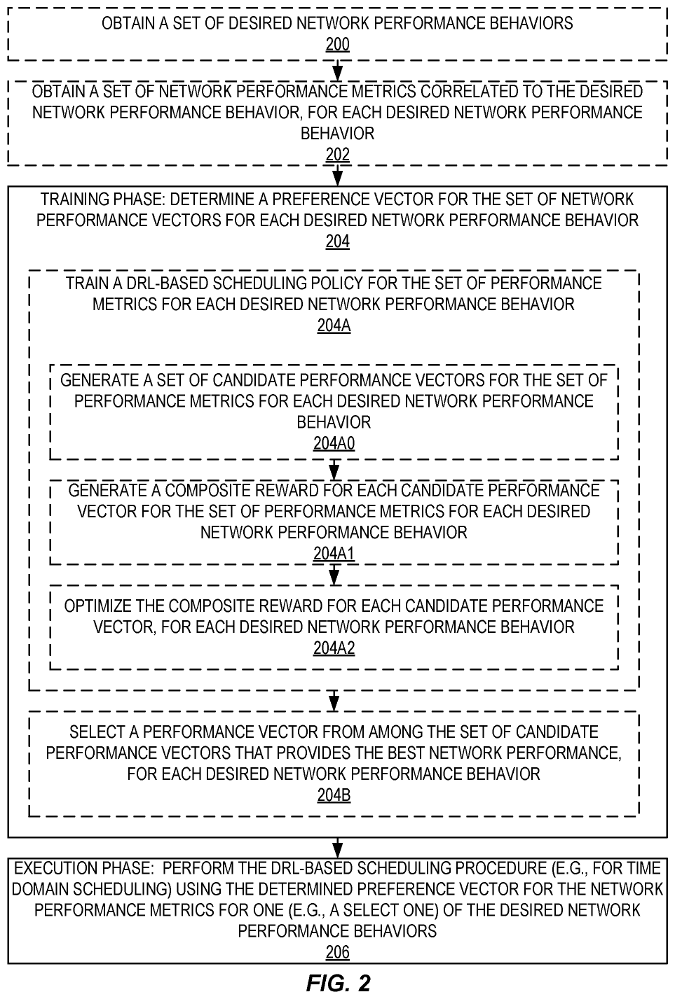

Now, a description of some example embodiments of the solution disclosed herein is provided. In one embodiment, a method of packet scheduling in cellular networks that is based on DRL is provided. In one embodiment, each desired network performance behavior in a set of desired network performance behaviors is correlated to a respective set of performance metrics (e.g., Key Performance Indicators (KPIs)) of the cellular network. Further, for each desired network performance behavior, a respective preference vector of weight values (e.g., scalar weight values) is assigned to the respective set of performance metrics and used to generate a composite reward function for the desired network performance behavior. As illustrated in FIG. 2 wherein optional steps are represented by dashed lines/boxes, in one embodiment, this method comprises the steps of:
Step 200 (Optional): Defining a set of desired network performance behaviors. The set of desired network performance behaviors may alternatively be otherwise obtained, predefined, or preconfigured.
Step 202 (Optional): For each desired network performance behavior, defining a set of performance metrics (e.g., KPIs) of the cellular network that are correlated with the desired network performance behavior. The set of performance metrics may alternatively be otherwise obtained, predefined, or preconfigured.
Step 204—Training Phase: For each desired network performance behavior, determining a preference vector (i.e., weight values) for the performance metrics correlated to the desired network performance behavior. In this embodiment, for each desired network performance behavior, the preference vector is determined by selecting the preference vector from a set of candidate preference vectors based on respective composite rewards generated using a training procedure for a DRL-based scheduling procedure, where the training procedure includes:
   Step 204A: Training a policy (e.g., a Q-function of a Deep Q Network (DQN)) of the DRL-based scheduling procedure for the set of performance metrics for each of the set of desired network performance behaviors. This training includes, in one embodiment:
   Step 204A0: Generating a set of candidate preference vectors for the set of performance metrics for each desired network performance behavior. The set of candidate preference vectors may alternatively be otherwise obtained, predefined, or preconfigured.
   Step 204A1: For each candidate preference vector for the set of performance metrics for each desired network performance behavior, generating a composite reward for the candidate preference vector by applying the candidate preference vector to the associated performance metrics, and
   Step 204A2: Optimizing the composite reward for each candidate preference vector, for each desired network performance behavior. This step optimizes the composite reward through the DRL-based scheduling procedure, where the DRL-based scheduling procedure maximizes the desired network performance behavior for each candidate preference vector.
   Step 204B: Selecting the candidate preference vector that provides best network performance (e.g., in terms of the respective desired network performance behavior) for each desired network performance behavior.
Step 206—Execution Phase: Performing the DRL-based scheduling procedure (e.g., for time-domain scheduling) using the determined preference vector (e.g., and the associated trained policy) for the network performance metrics correlated to one (e.g., a select one) of the desired network performance behaviors. based on the corresponding determined preference vector (and associated trained policy) to provide time domain scheduling of uplink and/or downlink packets.
   Note that, in one embodiment, both steps 204 and 206 are performed by a network node (e.g., a base station 101) where training is performed using previously collected and/or live data. In another embodiment, step 204 is performed offline (e.g., at a computer or computer system) where the results of the training are provided to a network node (e.g., a base station 102) and used by the network node to perform the execution phase (i.e., step 206).

The set of desired network performance behaviors may, e.g., be determined in the solution described herein or be determined externally to the solution disclosed herein (e.g., determined by some other procedure and provided as an input to the solution disclosed herein). In one embodiment, it is left to the preferences of the network operator to define the desired network behavior. For example, one network operator might prefer to maximize the throughput of the entire cell traffic or the Mobile Broadband (MBB) traffic. In another example, the network operator might aim at optimizing various QoS metrics such as maximizing the voice satisfaction (through minimizing packet delay), satisfying data flows associated with high-priority users, decreasing the jitter, etc. A desired network performance behavior might be defined as the combination of two or more of the above or similar objectives.

For each desired network performance behavior, the correlated set of performance metrics (e.g., KPIs) may include, e.g., any one or any combination to two or more of the following metrics: network throughput, fairness, transmission delay, QoS satisfaction in general, e.g. packet loss of VoIP users, etc.

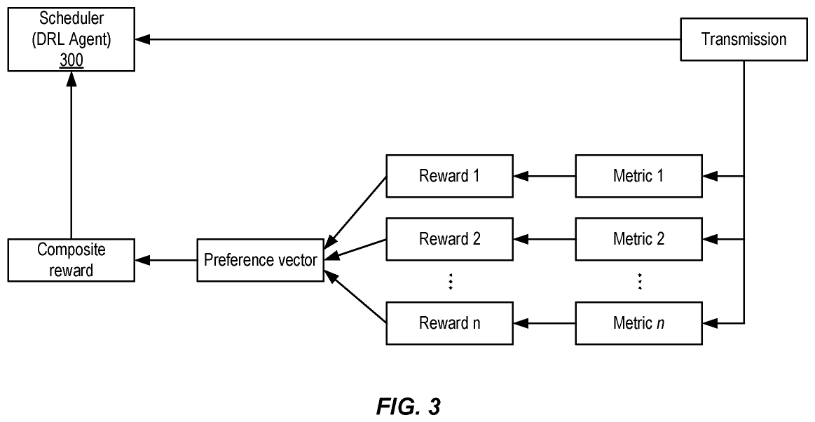

FIG. 3 is block diagram that illustrates a DRL-based scheduling procedure for a cellular network (e.g., for a base station 102 of the RAN of the cellular communications system 11) in accordance with an embodiment of the present disclosure. In particular, FIG. 3 generally illustrates steps 204 and 206 of the procedure described above. This procedure is performed by, in this example, a scheduler 300 including a DRL agent, where the scheduler 300 is, in one embodiment, implemented within a base station 102.

As illustrated, a composite reward function is constructed for each given desired network performance behavior (from step 200) by applying the respective preference vector (i.e., set of scalar weights) to the respective KPIs (from step 202) for the given desired network performance behavior. A key difficulty is the fact that an optimal preference vector that maximizes the desired network performance behavior cannot be derived mathematically from the input KPIs. Rather, the optimal preference vector must be found empirically. One way to find a good preference vector is to search within the space of possible weight values. As such, one may simply perform trial and error with different preference vector values to find out the best preference vector value. Although this idea seems feasible and easy to implement, applying it in an online fashion to a live communication network is practically infeasible. This is due to fact that, once a new preference vector value is chosen, the DRL agent requires a retraining phase which typically takes a significant time.

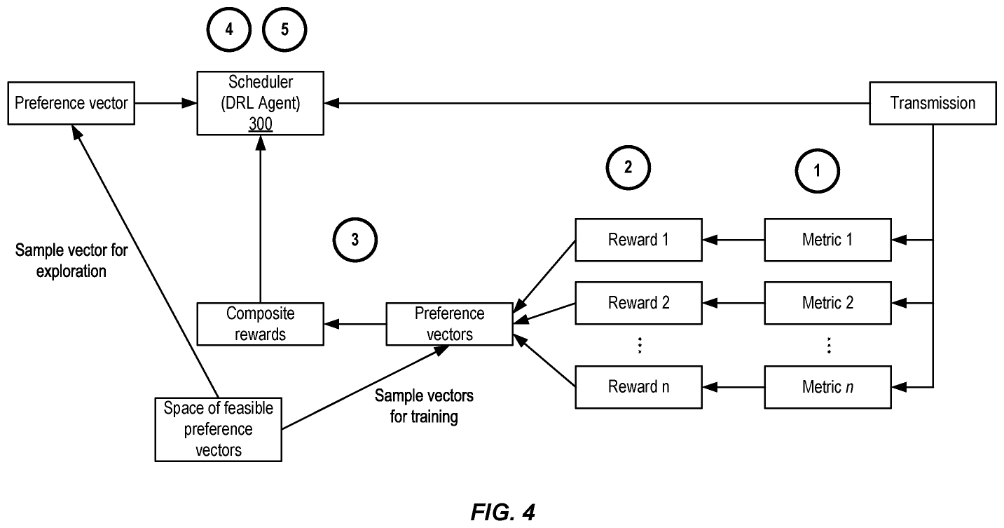

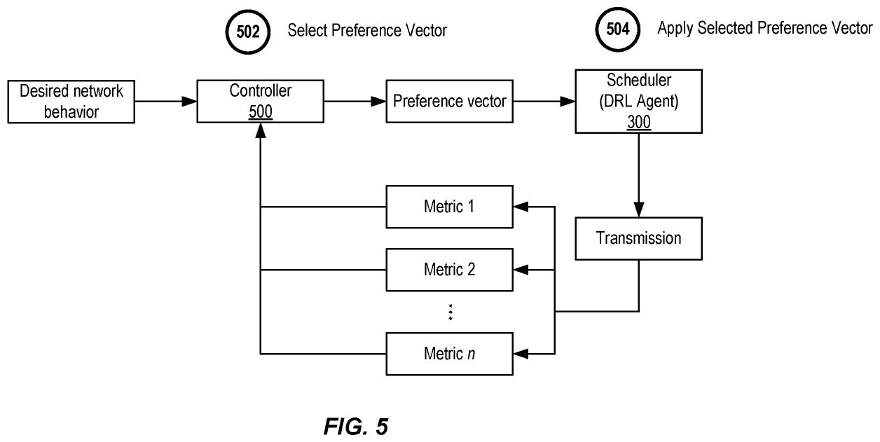

One example embodiment of a procedure for determining and using the optimal preference vector for a particular desired network performance behavior is illustrated in FIGS. 4 and 5. In particular, FIG. 4 illustrates a training phase (corresponding to step 204) in which the optimal preference vector is determined and an execution phase (corresponding to step 206) in which the determined preference vector is used to control (e.g., as an input to) the scheduler 300. Regarding training, by using off-policy DRL algorithms, e.g. deep Q-networks, it is possible to experiment with different candidates of the preference vectors (i.e., different candidate preference vector values) in an offline fashion using data collected from simulation or live network. In this way, different values of the preference vector can be chosen (as shown in FIG. 4) and the corresponding DRL-based scheduling procedure (i.e., a policy of the DRL-based scheduling procedure) can be trained and evaluated without interrupting the live network functionality or waiting for live data to train the scheduling procedure. The optimal behavior of the network then can be found by choosing the candidate preference vector that results in the best performance of the DRL scheduling procedure. In addition, in some embodiments, different variations of the DRL-based scheduling procedure are also considered, and the best combination of DRL-based scheduling variant and candidate preference vector is chosen.

More specifically, in one embodiment, the DRL-based scheduling procedure performs time-domain scheduling of packets for a TTI. For each TTI, the DRL-based scheduling procedure receives, as its input, an (unsorted) list of packets that need to be scheduled for transmission and outputs a sorted list of packets. The list of packets and the sorted list of packets each include a number (n) of packets. The sorted list encodes the priorities given to each packet which is then considered as frequency domain resources are allocated. In regard to training the policy of the DRL-based scheduling procedure, using a Deep Q-Network (DQN) as an example, the policy (or Q-function) of the DRL-based scheduling procedure can be expressed as:

Q:S×A→

[symbol]

where S is a state space and A is a discrete action space. In this example, the state space S is the union of an input state space Sᵢ and an output state space Sₒ of the DRL-based scheduling procedure. The input state space Sᵢ is all possible states of the input packet list, and the output state space Sₒ is all possible states of the sorted packet list. In these lists, each packet is represented as a vector of packet related variables such as, e.g., packet size, QoS requirements, delay, etc. In regard to the action space A, the actions in the action space are the packets in the input list that may be appended to the output sorted list. Thus, for an input list of size x, the action space is of dimension x. An action represents which element of the input list should next be appended to the output sorted list (selection sort). As will be appreciated by one of skill in the art of machine learning and, in particular DRL, during each iteration of the training procedure at corresponding time t, the policy, or Q-function in this example, is updated based on an update function (also referred to as an update rule). This update function is normally a function of a reward function, where the reward function is a function of the state Sₜ at time t, the action Aₜ at time t and the state Sₜ+1 at time t+1. However, in an embodiment of the present solution, the update function is a function of a composite reward that is generated by applying a preference vector for each of the performance metrics correlated to the given desired network performance behavior. Thus, as illustrated in FIG. 4, for each desired network performance behavior, the training procedure includes the following for each of a number of iterations i=1 . . . Numᵢₜₑᵣₐₜᵢₒₙₛ:
1) obtain values for the set of performance metrics correlated to the given desired network performance behavior that result from a transmission of a packet for iteration i;
2) compute individual reward values for the obtained performance metric values;
   a) Note: In one embodiment, actions are taken packet per packet, thus the training occurs packet by packet. However, the individual rewards (and subsequently the composite rewards) are computed following each TTI. Sₒ, feedback for training is given on a TTI level.
3) apply each of a set of candidate preference vectors to the computed individual reward values to generate a set of composite reward values;
4) update a separate policy for each candidate preference vector based on the respective composite reward values. This results in multiple trained policies (i.e., multiple trained Q-functions) for the respective candidate preference vectors.
5) Once the policies for the candidate preference vectors are trained, the candidate preference vector that provides the best performance for the desired network performance behavior is chosen as the preference vector for the desired network performance behavior. Also, the corresponding policy is chosen as the policy for the desired network performance behavior.

Following the training phase, the scheduler 300 may then be controlled through the chosen preference vector (e.g., solely through the chosen preference vector) for the given desired network performance behavior, as shown in FIG. 5.

In implementation, a controller 500 as illustrated in FIG. 5 can be considered. In one embodiment, the controller 500 implements a rule-based method which receives an input of a desired network performance behavior and chooses the corresponding preference vector that optimizes the selected behavior (step 502). In other words, the controller 500 selects the preference vector from among multiple preference vectors for respective sets of network performance metrics for respective network performance behaviors such that the selected preference vector is the one that optimizes the selected, or desired, network performance behavior. In regard to a rule-based method, the controller logic is fixed. However, more advanced rules are also possible. For example, the desired network performance behavior might vary based on time, traffic type, etc. As such, the resulting optimal preference vector selected by the controller 500 will also change. One example is the change of performance objective throughout the day to allow for different behaviors during night-time versus peak time.

In one embodiment, the final choice of preference vector made by the controller 500 may be dependent on multiple factors. For example, the selection of the preference vector to be used may be dependent on preference on maximum tolerable packet loss in relation to one or more data flows. In another embodiment, the selected preference vector is a function of the data flow characteristics, e.g. the mean of median payload size or the flow arrival rate.

In one embodiment, the controller 500 is implemented as a lookup table that contains the preference vectors for the different network performance behaviors or lower and upper bounds for the possible weight values for the preference vector given different network performance objectives. The actual preference vector is then calculated by picking any value in the allowed range of possible values.

In another embodiment, the search for a suitable preference vector may be scaled in the following manner. A set of feasible preference vector values are distributed across multiple BSs. The measured performance for these BSs is collected at a central node, along with the corresponding cell states. Subsequently, this information is used to estimate the optimal preference vector as a function of the cell state. The preference vector generated in this manner is then applied for scheduling in each individual BS (step 504).

In another embodiment, the network performance objectives (and consequently the optimal preference vector) can be operator specific, region specific, or RAT specific.

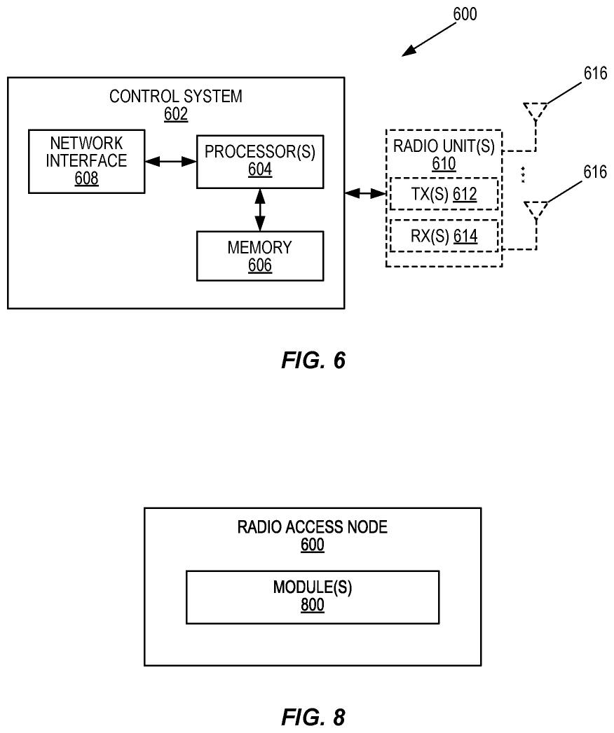

FIG. 6 is a schematic block diagram of a radio access node 600 according to some embodiments of the present disclosure. Optional features are represented by dashed boxes. The radio access node 600 may be, for example, a base station 102 or 106 or a network node that implements all or part of the functionality of the base station 102 described herein (e.g., all or part of the functionality of the scheduler 300 and/or controller 500 described herein). As illustrated, the radio access node 600 includes a control system 602 that includes one or more processors 604 (e.g., Central Processing Units (CPUs), Application Specific Integrated Circuits (ASICs), Field Programmable Gate Arrays (FPGAs), and/or the like), memory 606, and a network interface 608. The one or more processors 604 are also referred to herein as processing circuitry. In addition, the radio access node 600 may include one or more radio units 610 that each includes one or more transmitters 612 and one or more receivers 614 coupled to one or more antennas 616. The radio units 610 may be referred to or be part of radio interface circuitry. In some embodiments, the radio unit(s) 610 is external to the control system 602 and connected to the control system 602 via, e.g., a wired connection (e.g., an optical cable). However, in some other embodiments, the radio unit(s) 610 and potentially the antenna(s) 616 are integrated together with the control system 602. The one or more processors 604 operate to provide one or more functions of a radio access node 600 as described herein (e.g., all or part of the functionality of the scheduler 300 and/or controller 500 described herein). In some embodiments, the function(s) are implemented in software that is stored, e.g., in the memory 606 and executed by the one or more processors 604.

FIG. 7 is a schematic block diagram that illustrates a virtualized embodiment of the radio access node 600 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 600 in which at least a portion of the functionality of the radio access node 600 is implemented as a virtual component(s) (e.g., via a virtual machine(s) executing on a physical processing node(s) in a network(s)). As illustrated, in this example, the radio access node 600 may include the control system 602 and/or the one or more radio units 610, as described above. The control system 602 may be connected to the radio unit(s) 610 via, for example, an optical cable or the like. The radio access node 600 includes one or more processing nodes 700 coupled to or included as part of a network(s) 702. If present, the control system 602 or the radio unit(s) are connected to the processing node(s) 700 via the network 702. Each processing node 700 includes one or more processors 704 (e.g., CPUs, ASICs, FPGAs, and/or the like), memory 706, and a network interface 708.

In this example, functions 710 of the radio access node 600 described herein (e.g., all or part of the functionality of the scheduler 300 and/or controller 500 described herein) are implemented at the one or more processing nodes 700 or distributed across the one or more processing nodes 700 and the control system 602 and/or the radio unit(s) 610 in any desired manner. In some particular embodiments, some or all of the functions 710 of the radio access node 600 described herein are implemented as virtual components executed by one or more virtual machines implemented in a virtual environment(s) hosted by the processing node(s) 700. As will be appreciated by one of ordinary skill in the art, additional signaling or communication between the processing node(s) 700 and the control system 602 is used in order to carry out at least some of the desired functions 710. Notably, in some embodiments, the control system 602 may not be included, in which case the radio unit(s) 610 communicate directly with the processing node(s) 700 via an appropriate network interface(s).

In some embodiments, a computer program including instructions which, when executed by at least one processor, causes the at least one processor to carry out the functionality of radio access node 600 or a node (e.g., a processing node 700) implementing one or more of the functions 710 of the radio access node 600 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

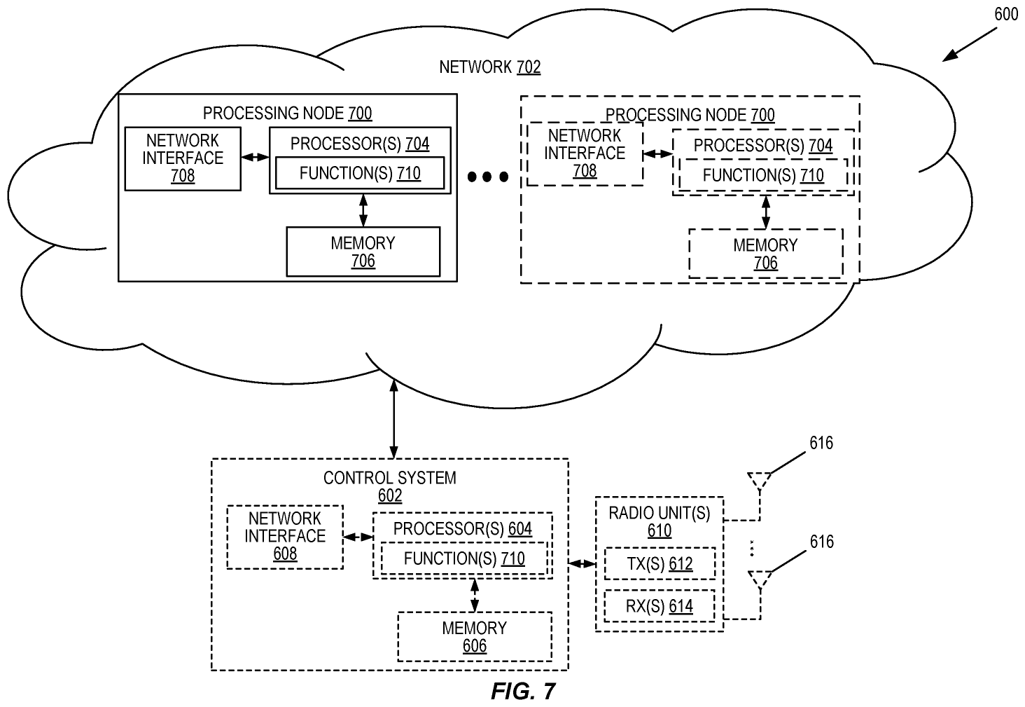

FIG. 8 is a schematic block diagram of the radio access node 600 according to some other embodiments of the present disclosure. The radio access node 600 includes one or more modules 800, each of which is implemented in software. The module(s) 800 provide the functionality of the radio access node 600 described herein (e.g., all or part of the functionality of the scheduler 300 and/or controller 500 described herein). This discussion is equally applicable to the processing node 700 of FIG. 7 where the modules 800 may be implemented at one of the processing nodes 700 or distributed across multiple processing nodes 700 and/or distributed across the processing node(s) 700 and the control system 602.

Note that some aspects (e.g., training) may be performed externally to the RAN, e.g., at a computing node. The computing node may be any type of computer or computer system (e.g., personal computer or other type of computer or computer system). A computing node includes one or more processing circuitries (e.g., CPU(s), ASIC(s), FPGA(s), or the like) configured to perform, e.g., at least some aspects of the training procedure described herein. The computing node may include additional hardware (e.g., memory such as, e.g., RAM, ROM, or the like), input/output devices (e.g., monitor, keyboard, or the like), and may also include software including instructions that when executed by the processing circuitry causes the computing node to perform at least some aspects of the training procedure disclosed herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunication and/or data communication protocols as well as instructions for carrying out one or more of the techniques described herein. In some implementations, the processing circuitry may be used to cause the respective functional unit to perform corresponding functions according to one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments are as follows:

Embodiment 1: A method performed by a network node (102) for Deep Reinforcement Learning, DRL, based scheduling, the method comprising performing (206) a DRL-based scheduling procedure using a preference vector for a plurality of network performance metrics correlated to one of a plurality of desired network performance behaviors, the preference vector defining weights for the plurality of network performance metrics correlated to the one of the plurality of desired network performance behaviors.

Embodiment 2: The method of embodiment 1 further comprising obtaining a plurality of preference vectors for respective sets of network performance metrics for the plurality of desired network performance behaviors, respectively.

Embodiment 3: The method of embodiment 1 or 2 wherein the plurality of network performance metrics comprise: (a) packet size, (b) packet delay, (c) Quality of Service, QoS, requirement(s), (d) cell state, or (e) a combination two or more of (a)-(d).

Embodiment 4: The method of any of embodiments 1 to 3 further comprising selecting the preference vector from among a plurality of preference vectors for respective sets of network performance metrics for a plurality of network performance behaviors, respectively.

Embodiment 5: The method of embodiment 4 wherein selecting the preference vector from among the plurality of preference vectors comprises selecting the preference vector from among the plurality of preference vectors based on one or more parameters.

Embodiment 6: The method of embodiment 5 wherein the selected preference vector varies over time.

Embodiment 7: The method of embodiment 5 or 6 wherein the one or more parameters comprise time of day or traffic type.

Embodiment 8: The method of any of embodiments 1 to 7 wherein the DRL-based scheduling procedure is a Deep Q-Learning Network, DQN, scheduling procedure.

Embodiment 9: The method of any of embodiments 1 to 8 wherein the DRL-based scheduling procedure performs time-domain scheduling of packets for each of a plurality of transmit time intervals, TTIs.

Embodiment 10: The method of any of embodiments 1 to 9 further comprising, prior to performing (206) the DRL-based scheduling procedure, determining (204) the preference vector for the desired network performance behavior.

Embodiment 11: The method of any of embodiments 1 to 9 further comprising, prior to performing (206) the DRL-based scheduling procedure, for each desired network performance behavior of the plurality of desired network performance behaviors: training (204A) a DRL-based policy for each of a plurality of candidate preference vectors for a plurality of network performance metrics correlated to the desired network performance behavior based on respective composite reward functions, each composite reward function being based on the plurality of network performance metrics correlated to the desired network performance behavior and a respective one of the plurality of candidate preference vectors; and selecting (204B), based on results of the training, the preference vector for the plurality of network performance metrics correlated to the desired network performance behavior from among the plurality of candidate preference vectors for the plurality of network performance metrics correlated to the desired network performance behavior.

Embodiment 12: A network node adapted to perform the method of any of embodiments 1 to 11.

Embodiment 13: A method of training a Deep Reinforcement Learning, DRL, based scheduling procedure, the method comprising: for each desired network performance behavior of a plurality of desired network performance behaviors:
training (204A) a DRL-based policy for each of a plurality of candidate preference vectors for a plurality of network performance metrics correlated to the desired network performance behavior based on respective composite reward functions, each composite reward function being based on the plurality of network performance metrics correlated to the desired network performance behavior and a respective one of the plurality of candidate preference vectors; and
selecting (204B), based on results of the training, the preference vector for the plurality of network performance metrics correlated to the desired network performance behavior from among the plurality of candidate preference vectors for the plurality of network performance metrics correlated to the desired network performance behavior based on results of the training.

Embodiment 14: A computing node or a network node adapted to perform the method of embodiment 13.

Embodiment 15: A method performed by a network node (102) for Deep Reinforcement Learning, DRL, based scheduling, the method comprising: determining (204), for each desired network performance behavior of a plurality of desired network performance behaviors, a preference vector to apply to a plurality of network performance metrics correlated to the desired network performance behavior, during a training phase of a DRL-based scheduling procedure that optimizes a composite reward generated from the plurality of network performance vectors using the preference vector; and during an execution phase of the DRL-based scheduling procedure, performing (206) the DRL-based scheduling procedure using the determined preference vector for the plurality of network performance metrics correlated to one of the plurality of desired network performance behaviors.

Embodiment 16: The method of embodiment 15 wherein determining (204) the preference vector for each desired network performance behavior of the plurality of desired network performance behaviors comprises, for each desired network performance behavior of the plurality of desired network performance behaviors:
training (204A) a DRL-based policy for each of a plurality of candidate preference vectors for the plurality of network performance metrics correlated to the desired network performance behavior based on respective composite reward functions, each composite reward function being based on the plurality of network performance metrics correlated to the desired network performance behavior and a respective one of the plurality of candidate preference vectors; and
selecting (2048), based on results of the training, the preference vector for the plurality of network performance metrics correlated to the desired network performance behavior from among the plurality of candidate preference vectors for the plurality of network performance metrics correlated to the desired network performance behavior.

Embodiment 17: A network node adapted to perform the method of embodiment 16.

Embodiment 18: A computer program product comprising a computer readable medium, the computer readable medium having computer readable code embodied therein, the computer readable code being configured such that, on execution by a suitable computer or processor, the computer or processor is caused to perform a method as claimed in any one of embodiments 1 to 11, 13, 15 or 16.

Embodiment 19: A method performed by a network node (102) for Deep Reinforcement Learning, DRL, based scheduling, the method comprising:
for each desired network performance behavior of a plurality of desired network performance behaviors:
   determining (204) a preference vector for a plurality of network performance metrics correlated to the desired network performance behavior, the preference vector defining weights for the plurality of network performance metrics correlated to the desired network performance behavior; and
performing (206) a DRL-based scheduling procedure using the preference vector for the plurality of network performance metrics correlated to one of the plurality of desired network performance behaviors.

Embodiment 20: The method of embodiment 19 wherein, for each desired network performance behavior of the plurality of desired network performance behaviors, determining (204) the preference vector for the plurality of network performance metrics correlated to the desired network performance behavior comprises: training (204A) a DRL-based policy for each of a plurality of candidate preference vectors for the plurality of network performance metrics correlated to the desired network performance behavior based on respective composite reward functions, each composite reward function being based on the plurality of network performance metrics correlated to the desired network performance behavior and a respective one of the plurality of candidate preference vectors; and selecting (2048), based on results of the training, the preference vector for the plurality of network performance metrics correlated to the desired network performance behavior from among the plurality of candidate preference vectors for the plurality of network performance metrics correlated to the desired network performance behavior.

Those skilled in the art will recognize improvements and modifications to the embodiments of the present disclosure. All such improvements and modifications are considered within the scope of the concepts disclosed herein.

1. A method performed by a network node for Deep Reinforcement Learning, DRL, based scheduling, the method comprising:
performing a DRL-based scheduling procedure using a preference vector for a plurality of network performance metrics correlated to one of a plurality of desired network performance behaviors, the preference vector defining weights for the plurality of network performance metrics correlated to the one of the plurality of desired network performance behaviors.

2. The method of claim 1 further comprising obtaining a plurality of preference vectors for respective sets of network performance metrics for the plurality of desired network performance behaviors, respectively.

3. The method of claim 1 wherein the plurality of network performance metrics comprise: (a) packet size, (b) packet delay, (c) Quality of Service, QoS, requirement(s), (d) cell state, or (e) a combination two or more of (a)-(d).

4. The method of claim 1 further comprising selecting the preference vector from among a plurality of preference vectors for respective sets of network performance metrics for a plurality of network performance behaviors, respectively.

5. The method of claim 4 wherein selecting the preference vector from among the plurality of preference vectors comprises selecting the preference vector from among the plurality of preference vectors based on one or more parameters.

6. (canceled)

7. (canceled)

8. The method of claim 1 wherein the DRL-based scheduling procedure is a Deep Q-Learning Network, DQN, scheduling procedure.

9. The method of claim 1 wherein the DRL-based scheduling procedure performs time-domain scheduling of packets for each of a plurality of transmit time intervals, TTIs.

10. The method of claim 1 further comprising, prior to performing the DRL-based scheduling procedure, determining the preference vector for the desired network performance behavior.

11. The method of claim 1 further comprising, prior to performing the DRL-based scheduling procedure, for each desired network performance behavior of the plurality of desired network performance behaviors:
training a DRL-based policy for each of a plurality of candidate preference vectors for a plurality of network performance metrics correlated to the desired network performance behavior based on respective composite reward functions, each composite reward function being based on the plurality of network performance metrics correlated to the desired network performance behavior and a respective one of the plurality of candidate preference vectors; and
selecting, based on results of the training, the preference vector for the plurality of network performance metrics correlated to the desired network performance behavior from among the plurality of candidate preference vectors for the plurality of network performance metrics correlated to the desired network performance behavior.

12. (canceled)

13. (canceled)

14. A network node for Deep Reinforcement Learning, DRL, based scheduling, the network node comprising processing circuitry configured to cause the network node to:
perform a DRL-based scheduling procedure using a preference vector for a plurality of network performance metrics correlated to one of a plurality of desired network performance behaviors, the preference vector defining weights for the plurality of network performance metrics correlated to the one of the plurality of desired network performance behaviors.

15-18. (canceled)

19. A method performed by a network node for Deep Reinforcement Learning, DRL, based scheduling, the method comprising:
determining, for each desired network performance behavior of a plurality of desired network performance behaviors, a preference vector to apply to a plurality of network performance metrics correlated to the desired network performance behavior, during a training phase of a DRL-based scheduling procedure that optimizes a composite reward generated from the plurality of network performance vectors using the preference vector; and
during an execution phase of the DRL-based scheduling procedure, performing the DRL-based scheduling procedure using the determined preference vector for the plurality of network performance metrics correlated to one of the plurality of desired network performance behaviors.

20. The method of claim 19 wherein determining the preference vector for each desired network performance behavior of the plurality of desired network performance behaviors comprises:
for each desired network performance behavior of the plurality of desired network performance behaviors:
training a DRL-based policy for each of a plurality of candidate preference vectors for the plurality of network performance metrics correlated to the desired network performance behavior based on respective composite reward functions, each composite reward function being based on the plurality of network performance metrics correlated to the desired network performance behavior and a respective one of the plurality of candidate preference vectors; and
selecting, based on results of the training, the preference vector for the plurality of network performance metrics correlated to the desired network performance behavior from among the plurality of candidate preference vectors for the plurality of network performance metrics correlated to the desired network performance behavior.

21. (canceled)

22. A network node for Deep Reinforcement Learning, DRL, based scheduling, the network node comprising processing circuitry configured to cause the network node to:
determine, for each desired network performance behavior of a plurality of desired network performance behaviors, a preference vector to apply to a plurality of network performance metrics correlated to the desired network performance behavior, during a training phase of a DRL-based scheduling procedure that optimizes a composite reward generated from the plurality of network performance vectors using the preference vector; and
during an execution phase of the DRL-based scheduling procedure, perform the DRL-based scheduling procedure using the determined preference vector for the plurality of network performance metrics correlated to one of the plurality of desired network performance behaviors.

23-25. (canceled)
